(19) United States
(12) Patent Application Publication
(10) Pub. No.: US 2009/0080744 A1
(43) Pub. Date: Mar. 26, 2009

(54) IMAGE DISPLAY SYSTEM, APPARATUS AND METHOD

(75) Inventor: Masafumi Sagawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/212,373

(22) Filed: Sep. 17, 2008

(30) Foreign Application Priority Data
Sep. 21, 2007 (JP) 2007-245163

(51) Int. Cl. G06K 9/00

(52) U.S. Cl. 382/131

(57) ABSTRACT

When a series of present images have been taken at a follow-up examination of a patient, correspondence data is produced, showing correspondence between the respective present images and past images that were taken at past examinations of the same patient under similar condition. The correspondence data is stored in association with the present images. In a normal mode of an image interpretation making terminal, a designated one of the present images is displayed on a monitor. When a comparison mode is selected, such past images that correspond to the designated present image are retrieved from among those taken at the respective past examinations with reference to the correspondence data, so that the present image and the corresponding past images are displayed in turn or in parallel on the monitor.

### FIELD OF THE INVENTION

The present invention relates to an image display system for displaying images obtained through at least a past examination as well as images newly obtained through an examination under similar condition to the past examination. The present invention relates also to an image display apparatus and an image display method for the image display system.

### BACKGROUND OF THE INVENTION

In medical facilities like hospitals, a variety of medical examination apparatuses, such as modalities for CR (computed radiography), CT (computer tomography), MRI (magnetic resonation imaging), PET (positron emission tomography) and ultrasonic diagnosis, have been widely used. Medical images taken by the modalities are used in medical diagnoses, taking an important roll on determining the nature of a condition of a patient.

For the diagnosis based on medical images, doctors of individual diagnosis and treatment departments generally ask a doctor in an inspection department, like a radiologist, for an interpretation of the medical images. In the inspection department, the doctor interprets the medical images and reports the interpretation. Then, the doctor in the diagnosis and treatment department examines the report on the image interpretation, hereinafter referred to as the image interpretation report, to diagnose a disorder (an injury or a disease) of the patient.

Recently, in order to improve work efficiency in the medical field, computerization of medical images and charts has been promoted. Under this trend, systems for making the above-mentioned image interpretation online have been suggested for example in JPA2007-066016 and JP No. 3639030.

In practice, medical examinations are often carried out periodically on the same patient at an interval of three months, six months or one year, to observe the course of an illness or the like. Concerning such examinations for follow-up observation, the doctor will make the image interpretation while monitoring past images obtained through past inspections or examinations as well as present images obtained through the latest inspection or examination, so the doctor may compare the present images with the past images to find out any differences between them, for example a change in size of an affected part. The result of comparison is written as a view or finding in the report.

In order to display and compare the present images with the past images, the doctor in charge of the image interpretation should retrieve those past images which correspond to the present images. Particularly on those examinations using CT or MRI scanners, tens or hundreds of images are taken at each examination. Therefore, it has been labor-consuming for the doctors to retrieve the corresponding past image or images from among a large number of past images. For this reason, there has been a great demand for an image interpretation system that makes it easy to display and compare the present image with the corresponding past image.

As a prior art relating to this demand, the above-mentioned JPA2007-066016 discloses an image interpretation report making apparatus that extracts such a present image that corresponds to a past image that was regarded as a key image in the previous examination, the key image being a characteristic image where an affected part or the like was found. This prior document also suggests displaying the past key image and several past images around the key image apposed with the corresponding present images.

However it is not always satisfactory for the follow-up observation to compare the images taken around the key image area. For example, concerning the cancer, the whole body of the patient is occasionally subjected to the image interpretation and comparison with the past images. In that case, as the above prior art just reads out the images around the key image, the doctor should read out other past images than those around the past key image while checking the correspondence between the present images and the past images.

The latter mentioned JP No. 3639030 discloses an image display system that correlates the present images with those past images which were taken at similar imaging positions to the respective present images, and displays the present images on a monitor while displaying the correlated past images to the displayed present images synchronously on another monitor. According to this prior art, the doctors do not need to read the corresponding past images by themselves.

However, because examinations for the follow-up observation can be made periodically several times in some cases, if the doctor wants to compare the images taken through the several times of follow-up examinations, the system according to the latter prior art needs a corresponding number of monitors to the number of the follow-up examinations. Then, the system would be expensive. Although the latter prior art discloses displaying a plurality of images on the same divided screen of the monitor, the reduced size of the images in the respective divisions of the screen is inconvenient for the image interpretation.

### SUMMARY OF THE INVENTION

In view of the foregoing, a primary object of the present invention is to provide a system, an apparatus and a method, which make it easy to display and compare many present images with many corresponding past images on the follow-up observation, without increasing the cost or reducing the visual convenience, even in a case where the examinations for follow-up observation have been made several times.

To achieve the above and other object, an image display system of the present invention comprises a data storage device for storing past data obtained through a past examination done on a test device, and present data obtained through a present examination of the test device under similar condition to the past examination, wherein the past data includes past images taken from the test device at diverse imaging positions, whereas the present data includes present images taken from the test device at diverse imaging positions; a correspondence data producing device for producing correspondence data that shows correspondence between the present images and the past images with respect to their imaging positions; a display device for displaying the present images and/or the past images; a designating device for designating at least one of the present images; and a display control device for controlling the display device, the display control device having a normal mode for displaying merely the designated present image on the display device, and a sequential comparison mode for extracting a corresponding past image to the designated present image from the past data with reference to the correspondence data, and displaying the designated present image and the corresponding past image in turn on the display device.

If the test device has gone through past examinations plural times under similar condition, the display control device extracts corresponding past images to the designated present image from respective past data of the past examinations and displays the designated present image and the corresponding past images in turn on the display device in the sequential comparison mode.

Preferably, the image display system further comprises a device for indicating which examination the image displayed on the display device was taken at.

According to a preferred embodiment, the display control device further has a parallel comparison mode for displaying the corresponding past image and the designated present image in parallel on the display device, wherein the past and present images are scrollable synchronously to display another couple of present and corresponding past images.

In the sequential comparison mode, the display control device may preferably controls the display device to display a plural number of present images or corresponding past images to the respective present images at a time.

In the parallel comparison mode, the display control device may preferably control the display device to display a plural number of present images and corresponding past images to the respective present images at a time.

If the test device has gone through past examinations plural times under similar condition, the display control device extracts corresponding past images to the designated present image from respective past data of the past examinations and displays the designated present image and the corresponding past images in parallel on the display device in the parallel comparison mode.

An image display apparatus of the present invention comprises a display device for displaying present images taken from a test device at a present examination and/or past images taken from the test device at a past examination under similar condition, the present and past images being taken at diverse imaging positions of the test device; a correspondence data producing device for producing correspondence data that shows correspondence between the present images and the past images with respect to their imaging positions; a designating device for designating at least one of the present images; and a display control device for controlling the display device, the display control device having a normal mode for displaying merely the designated present image on the display device, and a comparison mode for retrieving a corresponding past image to the designated present image with reference to the correspondence data, and displaying the designated present image and the corresponding past image on the display device.

An image display method for displaying present images taken from a test device at a present examination and past images taken from the test device at a past examination under similar condition, the present and past images being taken at diverse imaging positions of the test device, the method comprising steps of:

producing correspondence data that shows correspondence between the present images and the past images with respect to their imaging positions;

designating at least one of the present images;

displaying merely the designated present image on the display device in a normal mode;

retrieving a corresponding past image to the designated present image with reference to the correspondence data in a comparison mode; and

displaying the designated present image and the corresponding past image in turn or in parallel on the display device in the comparison mode.

Since the corresponding past image to the designated present image is extracted from the past data with reference to the correspondence data that shows correspondence between the past images and the present images with respect to their imaging positions, and the present image and the corresponding past image are displayed on the same display device in the comparison mode, the doctor in charge of image interpretation can easily compare the present image with the corresponding past image. Even if the test device has gone through the follow-up examinations many times and thus there are a plural number of corresponding past images to the designated present image, the present and past images may be displayed in turn on the same display device. Therefore, the individual images are displayed in a visible manner without raising the system cost.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram schematically illustrating a medical network system;

FIG. 2 is an explanatory diagram schematically illustrating of a structure of volume data and slice images;

FIG. 3 is a block diagram schematically illustrating a structure of an image interpretation report making terminal;

FIG. 4 is a block diagram schematically illustrating a structure of an image server;

FIG. 5 is an explanatory diagram illustrating a concept of correspondence between present data and past data;

FIG. 6 is an explanatory diagram illustrating an example of correspondence data;

FIG. 7 is an explanatory diagram illustrating an example of an image display screen;

FIG. 8 is an explanatory diagram illustrating an example of a report creation screen;

FIG. 9 is an explanatory diagram illustrating an example of the image display screen displaying a present image and a corresponding past image for comparison;

FIG. 10 is a flowchart illustrating a sequence of procedures for image-interpretation;

FIG. 11 is an explanatory diagram illustrating an embodiment of the image display screen displaying plural present images and their corresponding past images;

FIG. 12 is an explanatory diagram illustrating an embodiment of the image display screen displaying images taken at several times of follow-up examinations of the same patient;

FIG. 13 is an explanatory diagram illustrating an example of correspondence data that shows correspondence between data of the follow-up examinations;

FIG. 14 is a flowchart illustrating a sequence of procedures for image-interpretation, wherein the present image and the past images are displayed one after another;

FIG. 15 is an explanatory diagram illustrating the concept of serial display of the present and past images;

FIG. 16 is an explanatory diagram illustrating an embodiment of the image display screen, which is provided with an indicator for identifying the displayed image;

FIG. 17 is an explanatory diagram illustrating an embodiment of the image display screen, wherein a set of present images are displayed and switchable to a set of past images taken at a past follow-up examination; and

FIG. 18 is an explanatory diagram illustrating an embodiment of the report creation screen, which allows choice between a normal display mode, a parallel display mode and a serial display mode.

### DESCRIPTION OF THE PREFERRED EMBODIMENTS

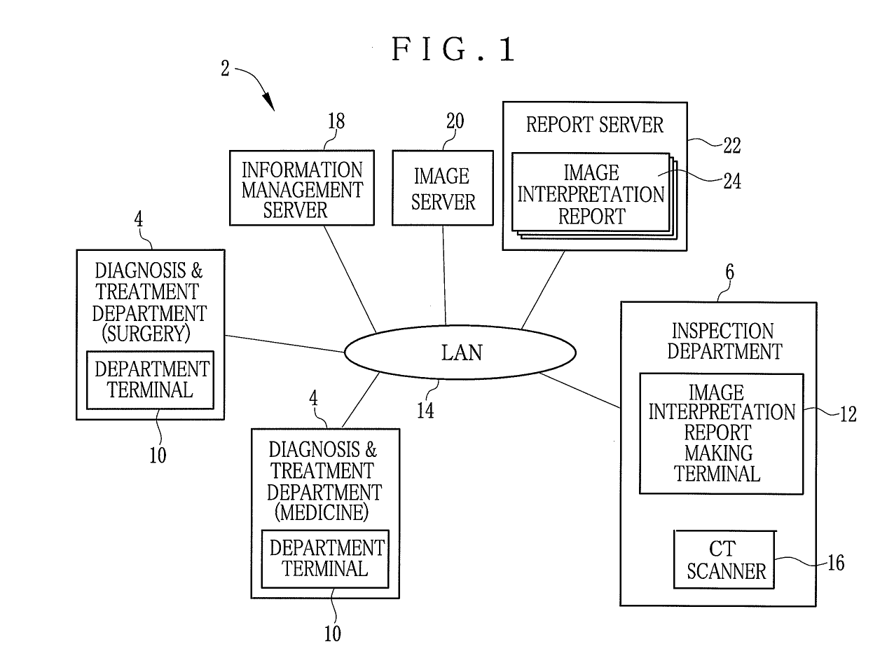

FIG. 1 shows a medical network system 2, which is installed in a medical facility like a hospital, as an embodiment of the image interpretation report making system of the present invention. The medical network system 2 consists of a plurality of department terminals 10 that are installed in respective diagnosis and treatment departments 4 like those for surgery, medicine etc., an image interpretation report making terminal 12 that is installed in an inspection department 6 like that for radiography, and a local area network (LAN) 14 interconnecting these terminals 10 and 12. To the LAN 14 are also connected a CT scanner 16, which is installed in the inspection department 6, an information management server 18, an image server 20 and a report server 22. The information management server 18 manages a variety of information inside the medical facility. The image server 20 is a data storage device storing various medical images including slice images 30 taken by the CT scanner 16. The report server 22 is a report storage device storing image interpretation reports 24, in which findings, views, opinions and diagnosis obtained by the image interpretation are written as comments or remarks.

A doctor in the individual diagnosis and treatment department 4 asks the inspection department 6 for an examination if it is necessary for diagnosing a disorder of a patient. In the inspection department 6, slice images 30 are taken from the patient according to the request from the diagnosis and treatment department 4. A doctor in the inspection department 6 interprets the slice images 30, makes an image interpretation report 24 on the results of interpretation of the slice images 30, and forwards the image interpretation report 24 back to the doctor who ordered the examination. On the basis of the image interpretation report 24, the doctor in the diagnosis and treatment department 4 finally makes a diagnosis. The medical network system 2 connects the respective department terminals 10 to the image interpretation report making terminal 12 via the LAN 14, so that the requests for examinations and the reports on image interpretation may be exchanged online, improving work efficiency in the medical facility. Note that more than one image interpretation report making terminal 12, more than one information management server 18, more than one image server 20 or more than one report server 22 may be connected to the LAN 14.

The information management server 18 is, for example, an HIS (hospital information system) server or a RIS (radiology information system) server. The information management server 18 manages various information including patient information, diagnosis and treatment information, examination information and account information in relation to respective patients. The patient information represents personal information on the individual patient, for example, patient's name, ID, address, birthday, age, sex, family, anamnesis or past illnesses and allergies.

The diagnosis and treatment information represents information on the diagnosis and treatment made to the patient, including the date of medical session, the department in charge, the name of disorder, the result of diagnosis, the duration of therapy, the kinds and amounts of prescribed drugs, the name of pharmacy in charge of medication, etc. The duration of therapy represents how long the patient has come to the medical facility for the therapy of the same disorder. The examination information represents information on medical images taken at each examination, including the date of examination, the machine used for the examination, the method of the examination and the site under the examination, etc. The information on the method of the examination includes directions and angles of taking the respective medical images, such as front and side, as well as whether radiopaque is used or not. The examined sites means body sites to be examined, such as head, neck, chest region, abdominal region, pelvic region, leg, trunk of body, etc. The account information includes for example charges for medical sessions, medications and inspections as well as whether the coverage is available or not.

The image server 20 is a so-called PACS (picture archiving and communication system for medical application) server. Beside the slice images 30, the image server 20 stores medical images sent from other medical facilities via a network or media and referential images for comparison between symptoms. The medical images are individually read out from the image server 20 to the department terminal 10 or the image interpretation report making terminal 12 according to the needs, so that doctors use them for image interpretation or explanation to the patient. Note that the medical images include not only the slice images 30 taken by the CT scanner 16 but also images taken by other modalities like CR machines and MRI scanners. The referential images include images showing various cases, which are taken by the modalities, and anatomic illustrations as well.

The report sever 22 stores the image interpretation reports 24 that are made as electronic data on the image interpretation report making terminal 12, and transfers the image interpretation reports 24 to the respective terminals 10 according to the demands from these terminals 10.

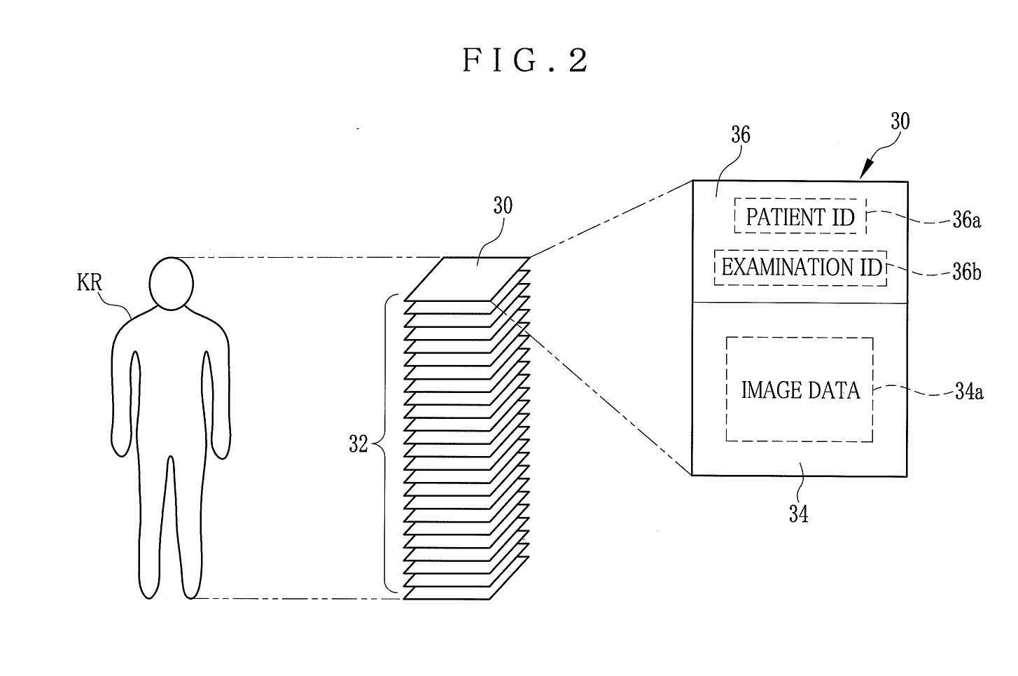

The CT scanner 16 takes a designed number of slice images 30 from a patient KR, as shown in FIG. 2, according to the order designating the slicing thickness and other set values for each individual examination. The slice images 30 obtained for each examination are transferred to the image server 20 and stored there in a group for each examination. Hereinafter, the group of slice images 30 will be referred to as volume data 32. If the volume data 32 contain images taken from more than one site, the images may be taken in continuous succession or with intermissions between different sites.

As shown in FIG. 2, the slice image 30 individually has an image recording area 34 for recording image data 34a and a tag area 36 for recording metadata, such as patient ID 36a, examination ID 36b and the like. The patient ID 36a is used to identify the patient KR whom the slice image 30 was taken from. The examination ID 36b is a specific number given to each examination, so that it is possible to identify the examination that the slice image 30 was taken for. With these IDs 36a and 36b, the slice images 30 for the same examination may be managed as a set of volume data 32.

Note that the metadata is not limited to the above embodiment, but any other information is recordable in the tag area 36 insofar as the information can identify the individual slice image 30. As an example of file format for such a medical image as having the tag area 36, DICOM (digital imaging and communications in medicine) format is usable.

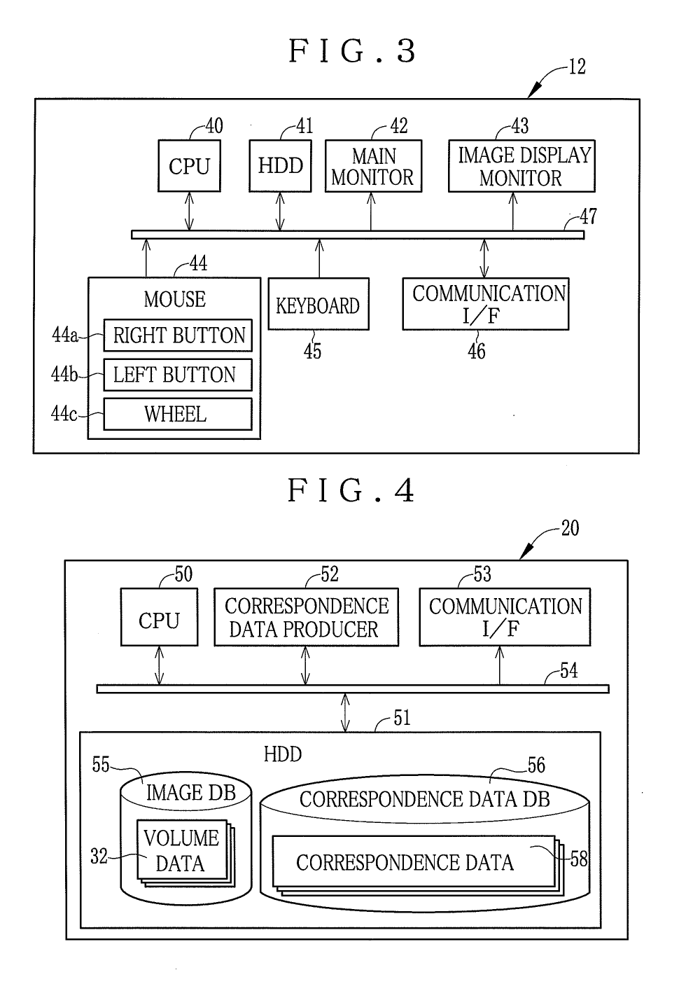

FIG. 3 schematically shows an internal structure of the image interpretation report making terminal 12 that embodies an image display apparatus of the present invention. The image interpretation report making terminal 12 may be a well-known personal computer or work station. The image interpretation report making terminal 12 is provided with a CPU 40 supervising respective components of the image interpretation report making terminal 12, an HDD 41 that stores various programs related to the medical network system 2, a main monitor 42 for displaying various work screens, an image display monitor 43 for displaying the slice images 30, well-known input devices like a mouse 44 and a keyboard 45, and a communication interface (I/F) 46 for connecting the image interpretation report making terminal 12 to the LAN 14. These components are interconnected via a bus 47. The CPU 40 embodies the display control device, the image display monitor 43 embodies the display device, and the mouse 44 embodies the image designation device of the present invention.

The CPU 40 sequentially processes the program as read from the HDD 41, to control the image interpretation report making terminal 12. The mouse 44 is provided with a right button 44a, a left button 44b and a wheel 44c, wherein the right button 44a is operated to display a predetermined operation list or the like on the respective monitors 42 and 43, and the left button 44b is operated to make a choice or a decision, whereas the wheel 44c is operated to scroll the displayed screen.

The image interpretation report making terminal 12 has a so-called dual monitor structure as having the monitors 42 and 43. The image display monitor 43 is a high-definition monitor that can display the slice image 30 in several mega pixels equivalently to the original pixel number of the individual slice image 30. While observing to interpret the slice images 30 displayed on the image display monitor 43, the doctor in charge of the image interpretation makes the image interpretation report 24 on a screen displayed on the main monitor 42. With these two monitors 42 and 43, the doctor can work out the image interpretation and the report making simultaneously on different screens, so the work efficiency of the image interpretation in the inspection department 6 is improved. However, the image interpretation report making terminal 12 is not limited to the dual monitor structure, but may be provided with a single monitor or more than two monitors.

FIG. 4 schematically shows an internal structure of the image server 20, which is provided with a CPU 50 supervising respective components of the image server 20, a hard disc drive (HDD) 51 storing various programs related to the medical network system 2, a correspondence data producer 52 for producing correspondence data 58, and a communication interface (I/F) 53 for connecting the image server 20 to the LAN 14. These components are interconnected via a bus 54. The CPU 50 reads the program from the HDD 51 and sequentially processes the program to control the image server 20.

The HDD 51 also constitutes an image database (DB) 55 storing various medical images including the volume data 32, and a corresponding information database 56 storing the correspondence data 58 as produced by the correspondence data producer 52. Note that the HDD 51 does not necessarily store both the programs and the image data, but it is possible to provide separate storage units. Although the medical images and other data are stored in the built-in HDD 51 in the present embodiment, it is also possible to store the data in an external storage device that is attachable or connectable to the medical network system 2, or in various media like DVD-ROM or CD-ROM.

In medical facilities like hospitals, medical examinations are often carried out periodically on the same patient at an interval of three months, six months or one year, to observe the course of an illness or the like. For an follow-up examination, the inspection department 6 takes the slice images 30 under the approximately same conditions as in the previous examination, so that the taken slice images 30 may be compared with those taken in the previous examination, wherein the conditions include positions of the site for observation and display conditions of the images.

The correspondence data producer 52 creates the correspondence data 58 that represents correspondence between the slice images 30 contained in the volume data 32 as obtained at the previous examination and the slice images 30 contained in the volume data 32 as obtained newly at the follow-up examination.

As the volume data 32 is newly sent from the CT scanner 16, the correspondence data producer 52 refers to the respective tag areas 36 of the slice images 30 contained in the newly sent volume data 32, to check the patient ID 36a and the examination ID 36b. On the basis of the confirmed IDs 36a and ID 36b, the correspondence data producer 52 reads out examination information of that volume data 32 from the information management server 18.

On the basis of the examination information read out from the volume data 32, the correspondence data producer 52 checks if the examination was carried out under the similar conditions as in the past examination of the same patient. Thereby, the correspondence data producer 52 judges whether the volume data 32 as sent from the CT scanner 16 was obtained at an initial examination of a case, or at a follow-up examination. If the correspondence data producer 52 judges the volume data 32 to be obtained at the initial examination, it stores the volume data 32 in the image database 55.

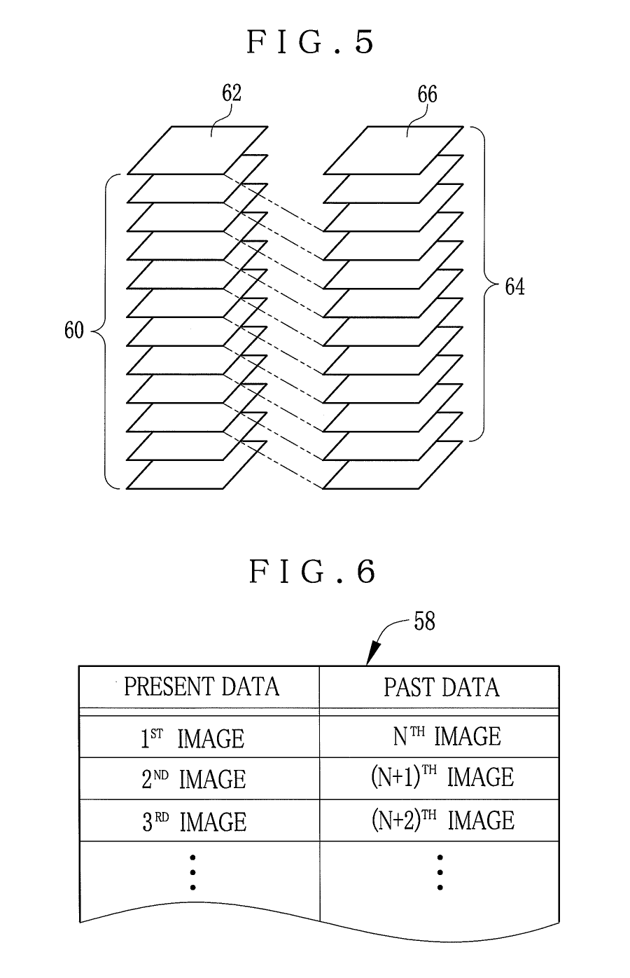

On the other hand, if the volume data 32 as sent from the CT scanner 16 is judged to be obtained at the follow-up examination, the correspondence data producer 52 reads out the volume data 32 as obtained at the previous examination, hereinafter referred to as the previous volume data 32, from the image database 55 on the basis of search results of the information management server 18. After reading the previous volume data 32, the correspondence data producer 52 determines the imaging position of each individual slice image 30 of the previous volume data 32 as obtained at the follow-up examination, to discriminate which slice images of the previous volume data 32 correspond to the respective slice images of the present volume data 32 with respect to their imaging positions. As shown in FIG. 5, the volume data 32 obtained newly at a follow-up examination will be referred to as present data 60, and slice images 30 contained in the present data 60 will be referred to as present images 62. On the other hand, the volume data 32 obtained at the previous examination will be referred to as past data 64, and slice images 30 contained in the past data 64 will be referred to as past images 66.

The judgment as to which past images 66 correspond to the respective present images 62 with respect to their imaging positions is made by calculating the respective imaging positions of the individual images 62 and 66 on the basis of some factors contained in the examination information, such as an initial imaging position, a final imaging position and a slicing thickness. The correspondence data producer 52 judges the correspondence of the individual present images 62 to the past images 66, and provides the result as the correspondence data 58. Note that the method of finding the correspondence between the present images 62 and the past images 66 is not limited to the above embodiment, but another method such as image analysis may be applicable.

The correspondence data 58 is produced for example in the form of a table that shows the respective serial numbers of those past images 66 which correspond to the present images 62 with regard to their imaging positions, as shown in FIG. 6. After producing the correspondence data 58, the correspondence data producer 52 writes the correspondence data 58 in the correspondence data database 56 and the present data 60 as well as the past data 64 in the image database 55. At that time, the correspondence data 58 is associated with the present data 60, for example by attaching the patient ID and the examination ID as metadata to the correspondence data 58.

Thus, the correspondence data producer 52 correlates the present images 62 with the past images 66 through the correspondence data 58. Note that the method of correlating the present images 62 with the past images 66 is described in more detail for example in JPA 2007-066016. Although the correspondence data 58 is produced as a data table in the present embodiment, the correspondence data 58 is not limited to this embodiment, but may be produced in association with each individual present image 62, for example, by recording information on the corresponding past image 66 as metadata in the tag area 36 of each present image 62. It is possible that the doctor in charge of image interpretation can manually produce and edit the correspondence data 58 by correlating the respective present images 62 with the past images 66.

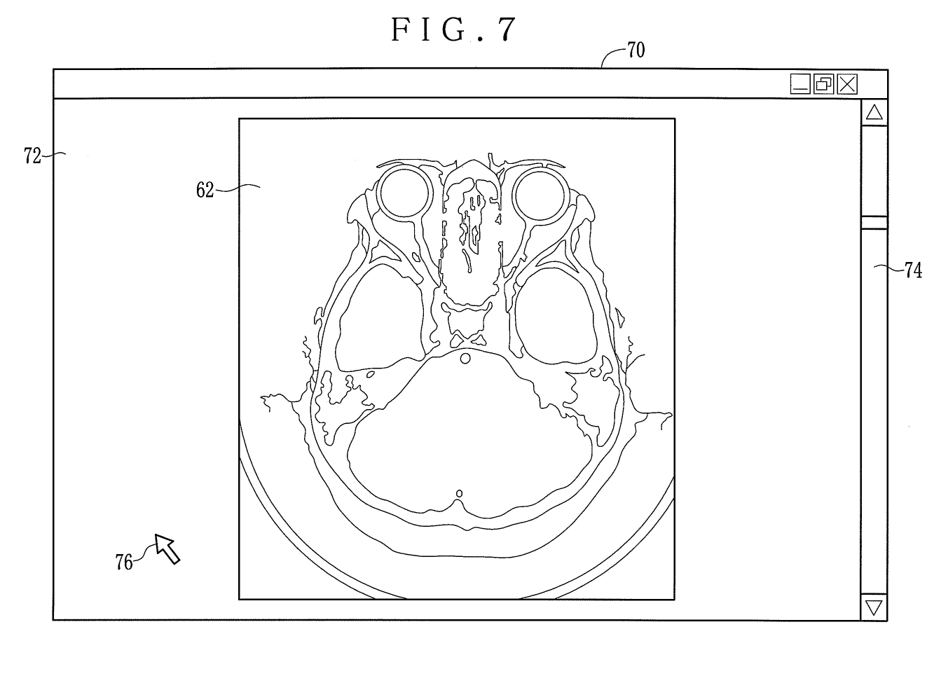

FIG. 7 shows an example of an image display screen 70 displayed on the image display monitor 43 of the image interpretation report making terminal 12. The image display screen 70 is displayed for example by selecting a particular request for an examination on a not-shown selection screen that shows a list of accepted examination requests. The image display screen 70 is provided with an image display area 72 for displaying the present image 62. On a right margin of the image display area 72 is displayed a scroll bar 74. A pointer 76 is also displayed on the image display screen 70, being movable on the image display screen 70 in cooperation with the mouse 44.

As one of the accepted examination requests is selected on the list, the CPU 40 of the image interpretation report making terminal 12 accesses to the image database 55 of the image server 20, to read out the present data 60 that correspond to the selected examination request. Then, the CPU 40 constitutes the image display screen 70 such that the respective present images 62 contained in the read present data 60 are arranged in the image display area 72 in the sequence of their imaging time, and displays the image display screen 70 on the image display monitor 43.

Moreover, the CPU 40 displays the present image 62 in an approximately maximum size relative to the image display screen 70, as shown in FIG. 7. The present image 62 displayed on the image display screen 70 is switchable by scrolling the image display area 72. The image display area 72 may be scrolled for example by rotating a wheel of the mouse 44 or drugging the scroll bar 74. The method of displaying the present image 62 is not limited to the illustrated embodiment, but it is possible to display many present images 62 in an array on the image display screen 70.

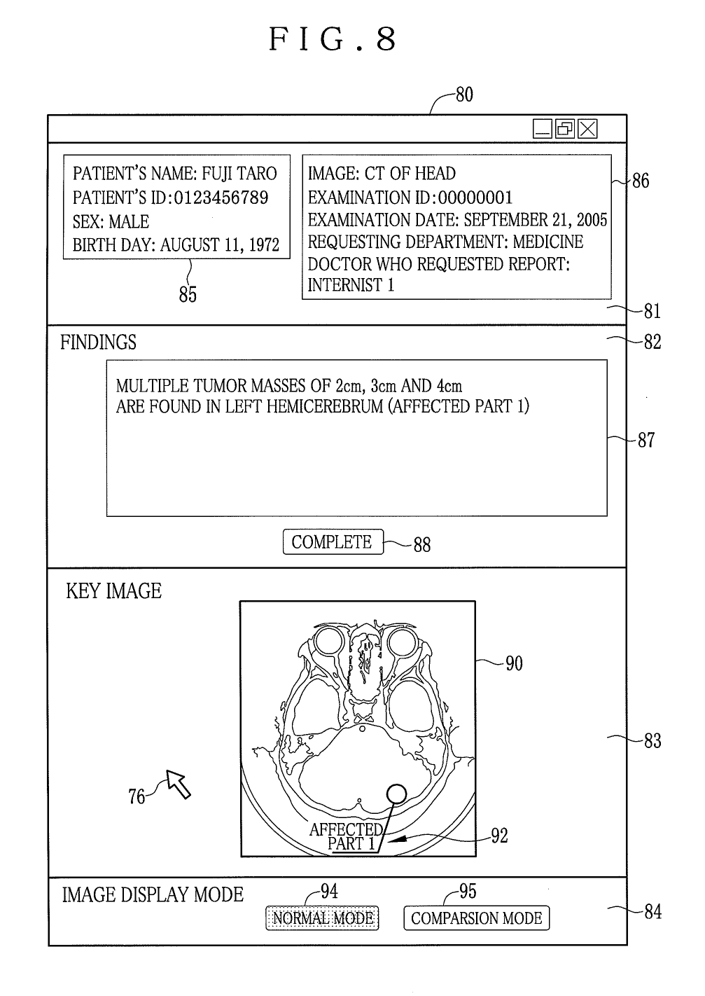

FIG. 8 shows an example of a report creation screen 80 displayed on the main monitor 42. Like the image display screen 70 on the image display monitor 43, the report creation screen 80 is displayed on the main monitor 42 when a particular request for an examination is selected. On the report creation screen 80, the pointer 76 is displayed as a common device to the image display screen 70. Where the image interpretation report making terminal 12 has the dual monitor structure, the common pointer 76 goes back and forth between the image display screen 70 and the report creation screen 80 according to the amount of operation on the mouse 44.

The report creation screen 80 is provided with an information display zone 81 for displaying various information, a comment input zone 82 for inputting comments such as findings, views, opinions and diagnoses, a key image pasting zone 83 for pasting a key image 90, and a display mode selection zone 84 for selecting a display mode of the image display screen 70. The information display zone 81 is provided with a patient data display box 85 and an examination data display box 86. The boxes 85 and 86 respectively display patient information and examination information, which are related to the selected examination request.

The comment input zone 82 is provided with a text input box 87 for inputting at least a finding as a comment, the finding explaining a condition seen from the image, and a complete button 88 for terminating creation of the image interpretation report 24. The doctor in charge of the image interpretation observes and interprets the respective present images 62 on the image display screen 70, and writes the comments in the text input box 87 through the keyboard 45, to write the image interpretation report 24. To complete making the image interpretation report 24, the doctor clicks the mouse 44 on the complete button 88. When the complete button 88 is clicked on, the CPU 40 of the image interpretation report making terminal 12 stores the image interpretation report 24 in the report server 22. At the same time, the CPU 40 informs of the completion of the image interpretation, for example, by e-mailing to the doctor who requested for the image interpretation report 24.

The key image 90 pasted in the key image pasting zone 83 is such an image that attracted attention of the doctor in charge of the image interpretation during the image interpretation. The key image 90 is produced by subjecting one of the present images 62 to image processing such as magnification or reduction, gradation control and the like. For example, the key image 90 is produced by drug-and-dropping one of the present images 62 from the image display screen 70 into the key image pasting zone 83.

On the key image 90, an annotation 92 is overlaid or superimposed, each of which consists of a mark locating a concerned site where the doctor in charge of the image interpretation finds an affected part or an illness. The annotation 92 is superimposed on the key image 90, for example, by indicating the concerned site with the pointer 76 and then inputting text data through the keyboard 45. The annotation 92 and the key image 90 are stored as parts of the image interpretation report 24 in the report server 22. Although the example shown in FIG. 8 shows only one key image 90 and one annotation 92, how many key images and annotations are to display depends on the number of affected parts found in the images.

The display mode selection zone 84 is provided with a normal mode selection button 94 for selecting a normal mode and a comparison mode selection button 95 for selecting a comparison mode. When the normal mode is selected, only one present image 62 is displayed in the image display area 72, as shown for example in FIG. 7, and the present image 62 is switched to another by scrolling the image display area 72. The image display screen 70 and the report creation screen 80 are displayed initially in this normal mode condition on the respective monitors 42 and 43.

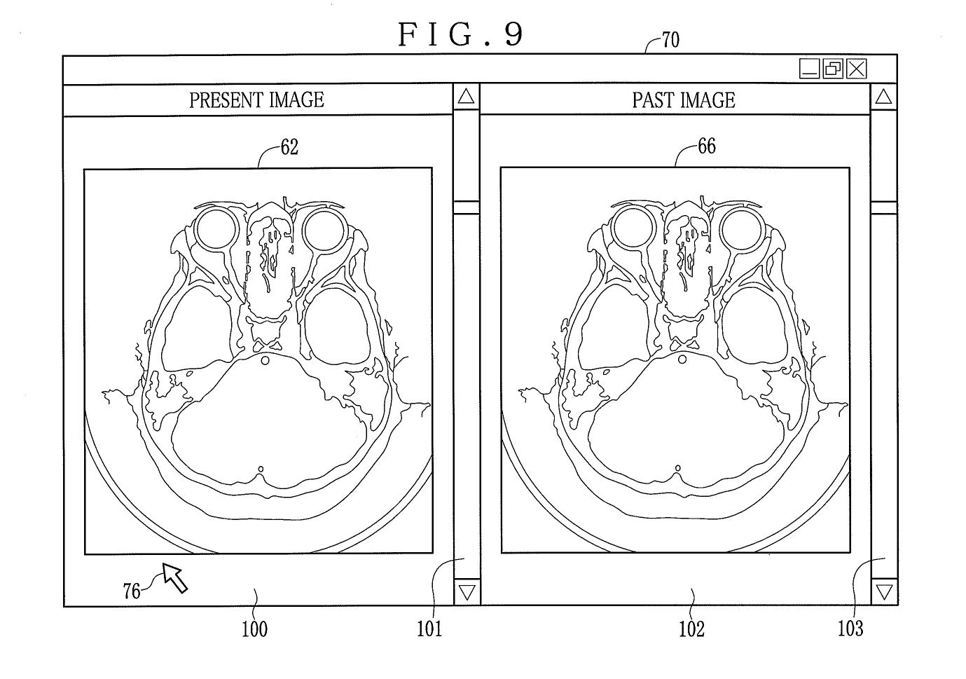

On the other hand, when the comparison mode selection button 95 is clicked on to select the comparison mode, the image display area 72 is divided into a present image display zone 100 and a past image display zone 102, as shown in FIG. 9, so that the present image 62 and the past image 66 are displayed in the respective zones 100 and 102. Moreover, individual scroll bars 101 and 103 are displayed on the right margins of the respective display zones 100 and 102.

Specifically, when the comparison mode is selected, the CPU 40 of the image interpretation report making terminal 12 makes an access to the correspondence data database 56 of the image server 20, to read such correspondence data 58 that corresponds to the present data 60 for image interpretation. With reference to the read correspondence data 58, the CPU 40 determines such past data 64 that corresponds to the present data 60, and reads the determined past data 64 out of the image database 55.

The CPU 40 also changes the layout of the image display screen 70 so that the image display area 72 is divided into the present image display zone 100 and the past image display zone 102. Then, on the basis of the correspondence data 58, the present image 62, which has been displayed in the image display area 72, is displayed in the present image display zone 100, whereas such a past image 66 that corresponds to the present image 62 in the present image display zone 100 is displayed in the past image display zone 102. Thus, the present image 62 and the corresponding past image 66 are displayed side by side on the image display screen 70. According to the rotation of the wheel 44c of the mouse 44, the CPU 40 causes the present image display zone 100 and the past image display zone 102 to scroll together so that the present image 62 and the past image 66 are synchronously switched over on the screen 70 to keep displaying the counterpart images 62 and 66 for comparison.

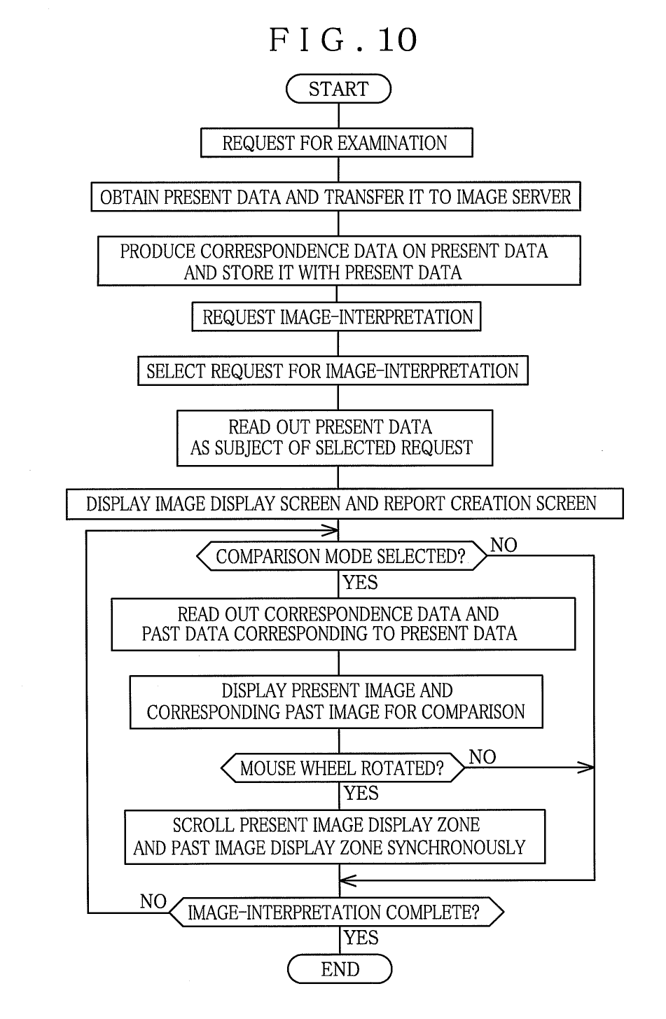

Now the operation of the medical network system 2 will be described with respect to a case of image-interpretation concerning a follow-up observation, while referring to the flowchart of FIG. 10. When a doctor of the diagnosis and treatment department 4 decides that an examination is necessary for follow-up observation of a patient, the doctor requests the inspection department 6 for the examination of the patient.

In response to the request for the examination for follow-observation, a doctor in the inspection department takes images from the patient under similar condition to the previous examination of the same case, to obtain the present data 60 that includes those present images 62 which correspond to the past images 66 with respect to their imaging positions to the aimed affected part of the patient as well as their display conditions. The obtained present data 60 is transferred to the image server 20. Then, the present request for examination is automatically put on a work list of a doctor in charge of the image interpretation.

When the image server 20 receives the present data 60 from the inspection department 6, the CPU 50 inputs the present data 60 in the correspondence data producer 52. Then, the correspondence data producer 52 finds the correspondence between the present images 62 and the past images 66 and produces the correspondence data 58 for the present data 60, which associates the respective present images 62 with the corresponding past images. The correspondence data producer 52 stores the produced corresponding data 58 in the correspondence data database 56, and stores the present data 60 in the image database 55.

The doctor in charge of image interpretation in the inspection department 6 refers to the work list through the image interpretation report making terminal 12, and selects an appropriate one of the worked-out requests for examination on the list. Then, the CPU 40 of the image interpretation report making terminal 12 starts the image interpretation program by accessing to the image database 55 to read such present data 60 that corresponds to the selected examination request. After reading the present data 60, the CPU 40 displays the image display screen 70 of the normal mode (see FIG. 7) on the image display monitor 43. The CPU 40 simultaneously displays the report creation screen 80 on the main monitor 42.

The doctor in charge of the image interpretation interprets the present images 62 displayed on the image display screen 70, writes findings in the comment input zone 82 of the report creation screen 80, pastes a key image 90 in the key image pasting zone 83 and puts the annotation 92 on the key image 90, to complete the image interpretation report 24. If necessary, the doctor clicks on the comparison mode button 95 to set the image display screen 70 in the comparison mode during the image interpretation.

When the comparison mode is selected, the CPU 40 reads out the correspondence data 58 and the past data 64 from the respective databases 55 and 56 correspondingly to the present data 60 that is subjected to the image interpretation. Thereafter, the CPU 40 changes the layout of the image display screen 70 for the comparison mode and displays the present images 62 and the corresponding past images 66 respectively in the present image display zone 100 and in the past image display zone 102 (see FIG. 9) As the wheel 44c of the mouse 44 is rotated, the CPU 40 lets both the present image display zone 100 and the past image display zone 102 scroll together according to the rotational amount of the wheel 44c, so that the present image 62 is kept displayed with its counterpart past image 66.

The doctor in charge of the image interpretation compares the present image 62 with the counterpart past image 66 on the screen 70, to make the image interpretation. After completing the image interpretation report 24, the doctor clicks on the complete button 88. Upon the complete button 88 being clicked, the CPU 40 stores the just produced image interpretation report 24 in the report server 22. Simultaneously, when the image interpretation report 24 is complete, the CPU 40 notifies the doctor who requested the image interpretation of the completion of the report 24 through an e-mail or the like.

As described so far, in the comparison mode, the past data 64 corresponding to the present data 60 is automatically retrieved from the image database 55 on the basis of the correspondence data 58, and the present images 62 are always displayed with their counterpart past images 66 by scrolling the present image display zone 100 and the past image display zone 102 together with the rotation of the wheel 44c. Therefore, the doctor in charge of the image interpretation can interpret the present images in comparison with their counterpart past images, without the need for searching for the corresponding past images 66 to the present images 62 by oneself.

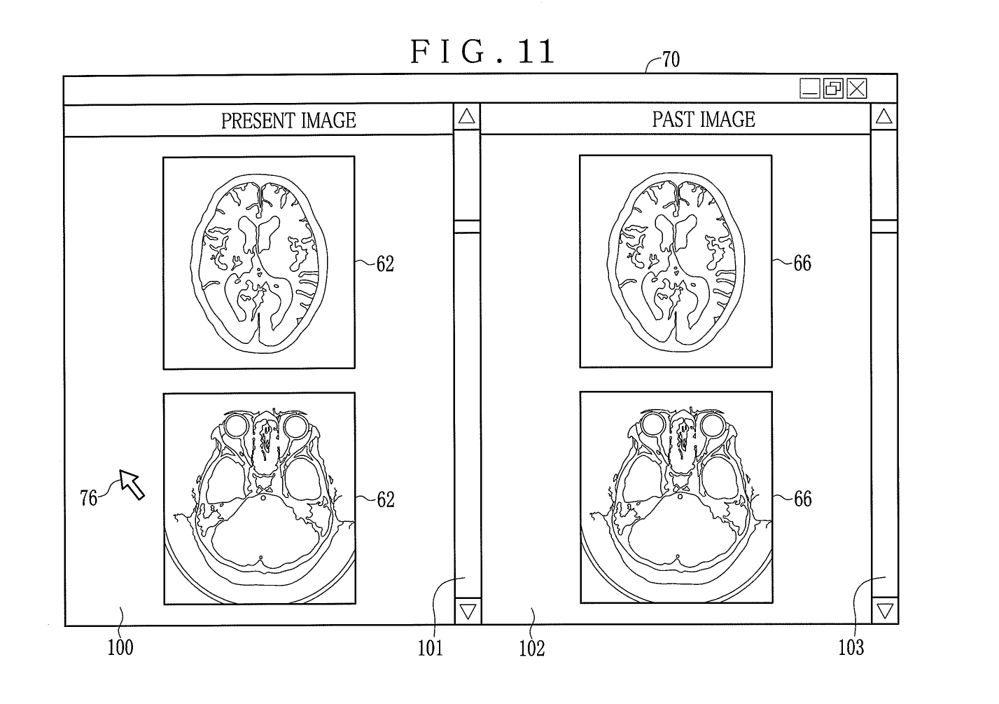

Although the above-described embodiment displays the present image 62 and the past image 66 one by one in the respective display zones 100 and 102, it is possible to display more than one image in either display zone 100 or 102. For example, as shown in FIG. 11, it is possible to display a couple of images 62 or 66 at once in the display zone 100 or 102. In that case, the displayed images 62 or 66 may be scrolled one by one or two by two. It is also possible to display more than two images in either display zone 100 or 102.

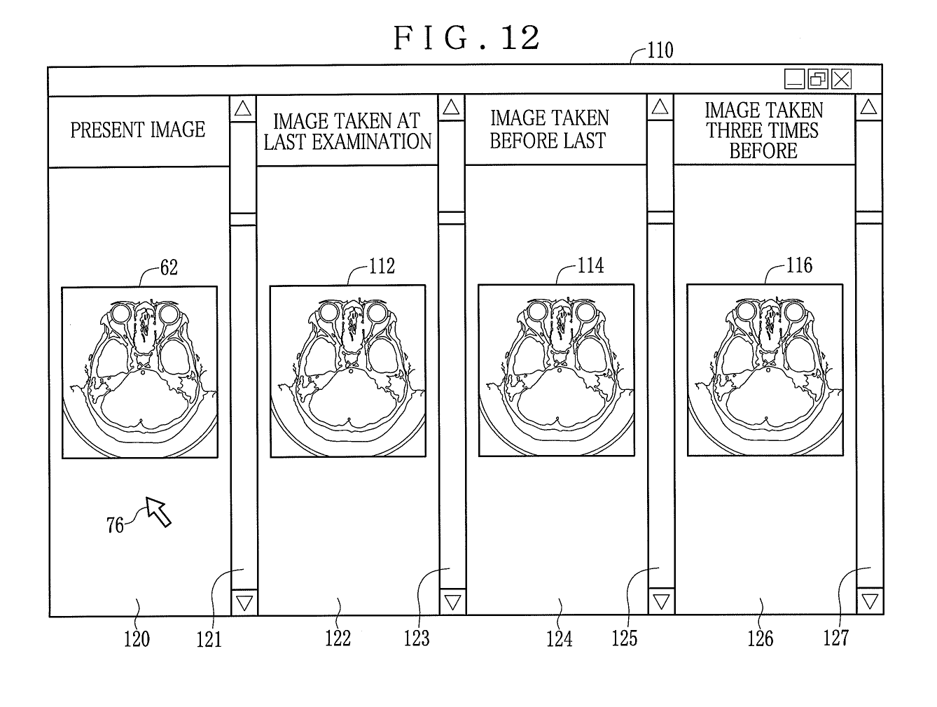

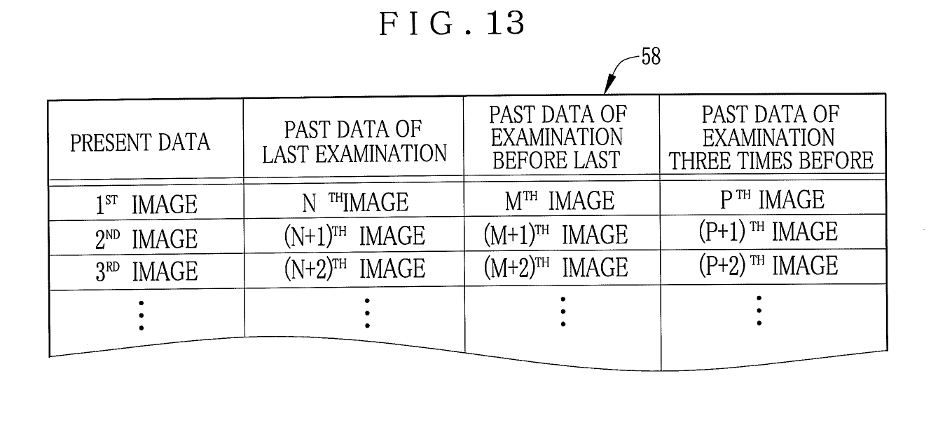

Although the above embodiment has been described with respect to a case where only one examination was carried out on the same patient before the present examination, examinations for follow-up observation are often carried out several times. For example, where the present exanimation is the fourth examination for follow-up observation of a patient, it is preferable to provide an image display screen 110 with four display zones 120, 122, 124 and 126, as shown in FIG. 12, for displaying the present image and past images 112, 114 and 116, which were taken at last examination, the examination before last, and the examination three times before, respectively. Scroll bars 121, 123, 125 and 127 are provided on the right margins of the individual display zones 120, 122, 124 and 126.

This way, where the examinations of the same patient have been carried out four times, including the present one, the past three images 112, 114 and 116 can be displayed as comparatives to the present image 62. In that case, the correspondence data 58 should be revised each time a follow-up examination is carried out, by correlating the present data 60 with the past data 64 obtained at the preceding examination. Then, the correspondence between the images obtained at the respective examinations is clarified. Of course, the follow-up observation can be carried out more than three times. In that case, it is preferable to configure the display apparatus of the present invention such that the doctor in charge of image interpretation can set up the number of past examinations, of which images are to be displayed as comparatives to the present image on the same display screen.

Although the image display apparatus of the above embodiment is provided with the normal mode for displaying the present image 62 alone and the comparison mode for displaying the past image 66 for comparison with the present image, it is possible to provide the display apparatus of the present invention merely with the comparison mode.

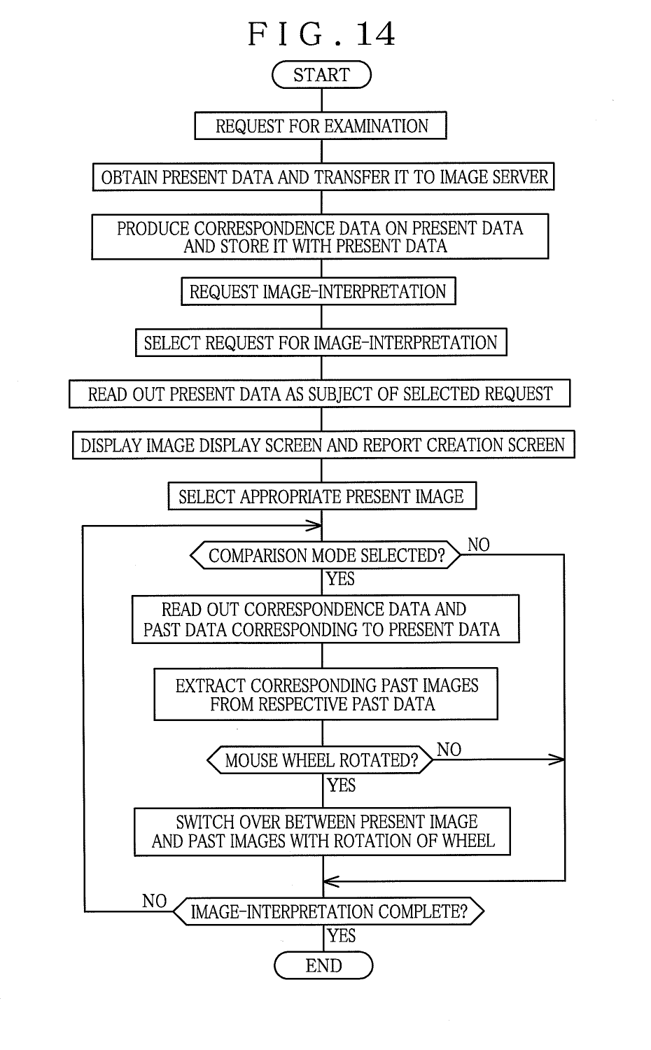

Now the operation of another embodiment will be described with reference to the flowchart of FIG. 14, wherein equivalent features to the first embodiment are designated by the same reference numerals in the present embodiment, so the details of the equivalent features will be skipped in the flowing description.

Like the first embodiment, the CPU 40 of the image interpretation report making terminal 12 reads out the present data 60 in response to a command for starting the image interpretation, and displays the image display screen 70 of the normal mode and the report creation screen 80 on the respective monitors 42 and 43.

After the screens 70 and 80 are displayed, the doctor in charge of the image interpretation rotates the wheel 44c of the mouse 44 to scroll the image display area 72 of the image display screen 70, to display an appropriate one of the present images 62, which may for example be designated as the key image 90. After making the appropriate present image 62 displayed in the image display area 72, the doctor clicks on the comparison mode 95 to set the image display screen 70 to the comparison mode.

In the comparison mode, the CPU 40 reads out the correspondence data 58 and the past data 64 from the databases 55 and 56 in correspondence to the present data 60 as the subject of the image interpretation. In this embodiment, the past data 64 were obtained by past three examinations of the same patient. On the basis of the read correspondence data 58, the CPU 40 extracts those past images 112, 114 and 116 from the respective past data 64 of the past three examinations, which correspond to the present image 62 designated on the image display screen 70.

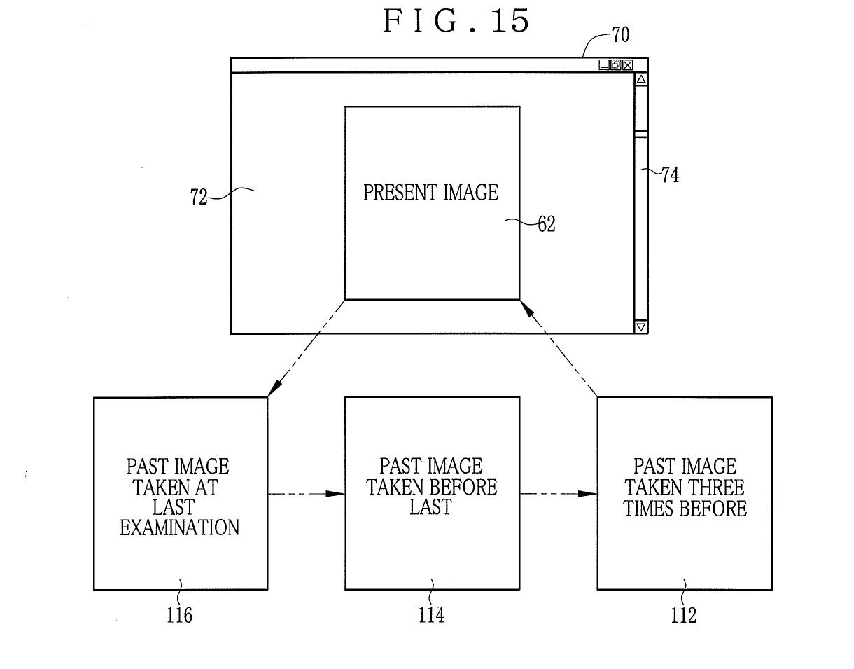

After the past images 112, 114 and 116 are extracted, the present image 62, the past image 112 taken at last examination, the past image 114 taken at the examination before last and the past image 116 taken at the examination three times before are displayed by turns in the image display area 72 of the image display screen 70 along with the rotation of the wheel 44c, as shown in FIG. 15. Displaying the images 62, 112, 114 and 116 one after another on the image display screen 70 in this way facilitates comparison of the present image with the past images, reduces the labor of the doctor in charge, and thus improves operability of the display apparatus for the image interpretation.

The embodiment shown in FIG. 12, wherein the present and past images 62, 112, 114 and 116 are displayed in parallel, has a problem that the individual images come to be too small for the doctor to observe and interpret them with ease. On the contrary, where the present image 62 and the past images 112, 114 and 116 are displayed serially, i.e. one after another, in the same image display zone 72, like in the embodiment FIG. 15, the individual images can always be displayed in full size, even while a certain number of follow-up examinations have been carried out on the same patient. Since there is no need for installing individual monitors for displaying the present and respective past images 62, 112, 114 and 116, the serial display system would not be costly.

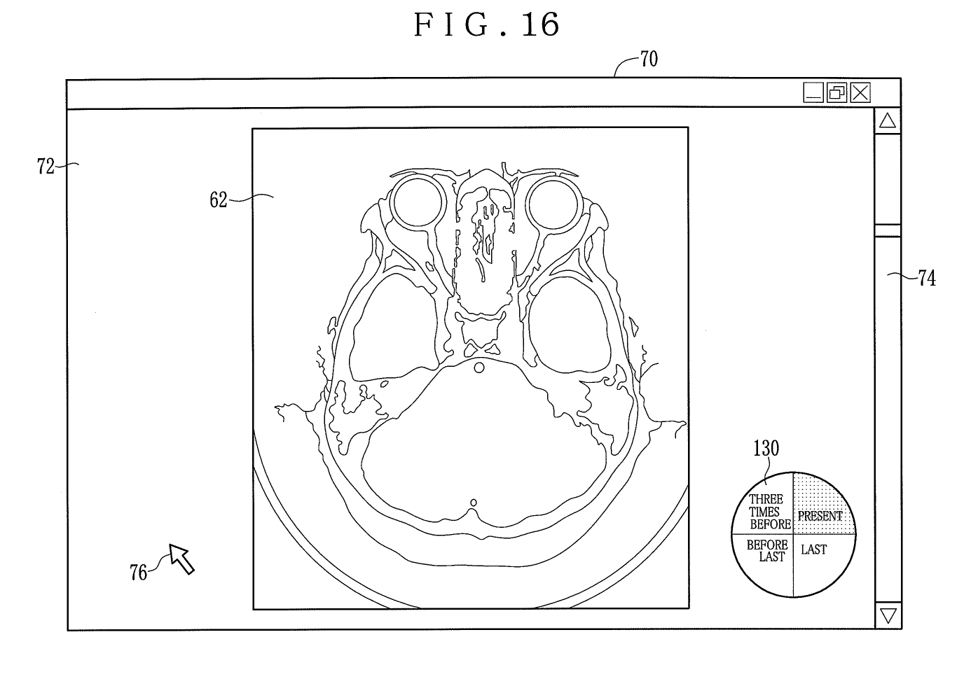

If, however, the present and past images 62, 112, 114 and 116 are simply displayed one after another in the same image display zone 72, there is a problem that the doctor cannot identify or discriminate between the images taken at different examinations. To solve this problem, it is preferable to display an indicator 130 beside the image as serially displayed in the image display area 72, like as shown in FIG. 16, for indicating at which examination the displayed image was taken.

Although the indicator 130 has a shape of a circle graph in FIG. 16, the indicator 130 may have another shape, like a bar graph. However, considering the area the indicator 130 can take up in the image display area 72, the circular shape like shown in FIG. 16 is the most preferable. Although the indicator 130 is displayed so as not to overlap the image 62, the indicator 130 may overlap the image. Moreover, the device for indicating the time of the examination at which the displayed image was taken is not limited to the indicator displayed in the image display area 72, but may for example be a lamp or an LED that is turned on or off to indicate the displayed image, or a text or string displayed on the image display screen 70, or a speaker announcing the displayed image.

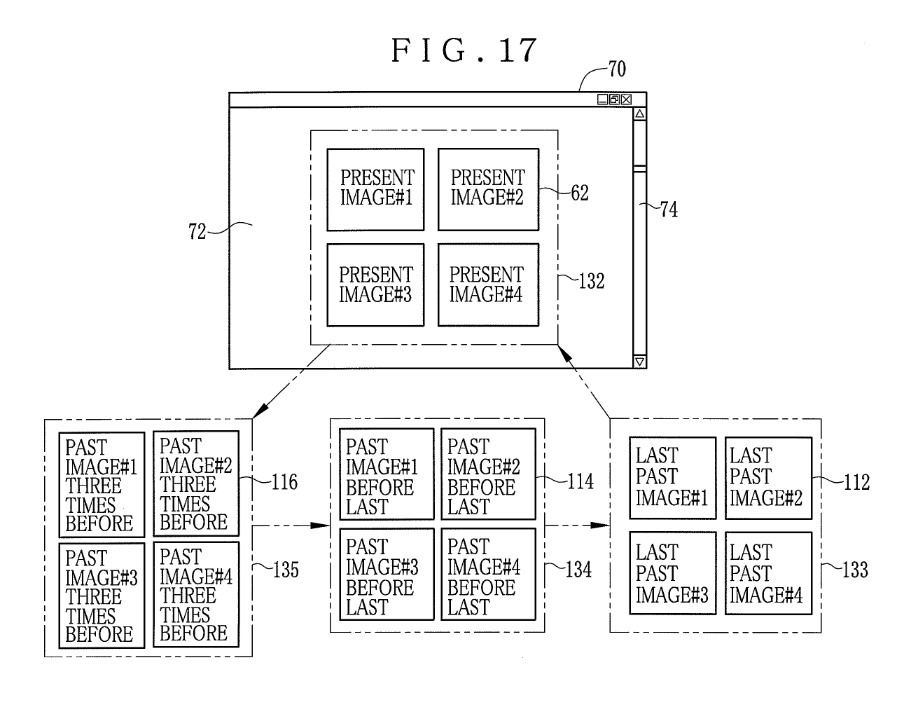

Although the images 62, 112, 114 and 116 are switched from one to another on the image display screen 70 in the embodiment shown in FIG. 15, it is also possible to display several images of the same examination at once in the image display area 72 and switch to a corresponding set of images of the next examination, as shown in FIG. 17.

Specifically, several present images 62 are selected and arranged to form a set 132 in the normal mode. Thereafter, when the comparison mode is selected, corresponding past images 112 to the selected present images 62 are extracted from the past data 64 of last examination, and arranged to form a corresponding set 133 of the extracted past images 112. Likewise, corresponding past images 114 and 116 to the selected present images 62 are extracted from the past data 64 of the examination before last and from the past data 64 of the examination three times before, respectively, and arranged to form a corresponding set 134 of the extracted past images 114 and a corresponding set 135 of the extracted past image 116. Then, as the mouse wheel 44c is rotated, the image display area 72 is switched over, displaying the set 132 of the extracted present images 62 and the respective sets 133, 134 and 135 of the corresponding past images 112, 114 and 116, sequentially from one set to another.

As the corresponding images are arranged at the same positions of every set 132, 133, 134 and 135 in the image display area 72, the doctor can appropriately compare between the corresponding images even while several images are displayed at once. Note that the number of images displayed in a set is not limited to four, but may of course be two, three, five or more. It is preferable to allow the doctor to set up the number of images displayed at once in the image display area 72.

Although the display in the image display area 72 is switched with the rotation of the mouse wheel 44c in the above embodiment, the timing of switching the image display area 72 is not limited to this embodiment. For example, it is possible to switch the display at constant time intervals while counting the time by a system timer or the like.

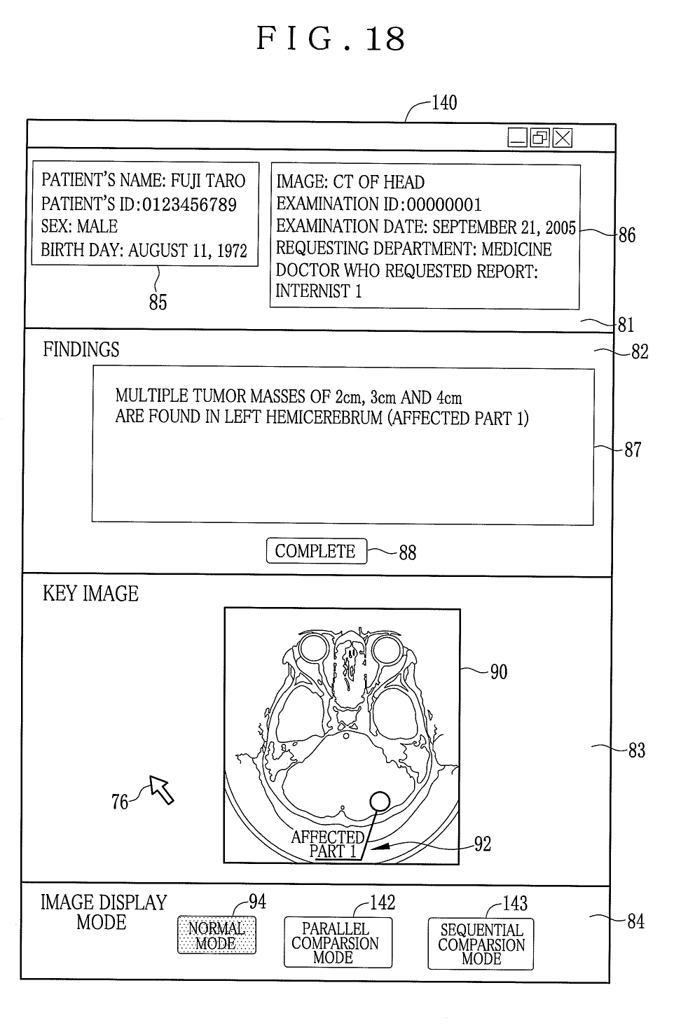

It is also possible to provide a parallel comparison mode and a sequential comparison mode beside the normal mode. For example, as shown in FIG. 18, a report creation screen 140 may be provided with a parallel comparison mode button 142 for displaying a present image 62 and at least a corresponding past image 66 side by side, and a sequential comparison mode button 143 for displaying the present image 62 and the corresponding past image 66 in turn.

Although the slice images 30 taken by the CT scanner 16 are referred to as the present and past images 62 and 66 in the above-described embodiment, the present and past images 62 and 66 are not limited to this embodiment, but may be those taken by a MRI scanner or a PET scanner. Moreover, in the above-described embodiment, an axial or transaxial slice image, which is taken in a perpendicular direction to a body axis of the patient, is shown as an example of the slice image 30, but the slice image 30 may be a sagittal slice image or a coronal slice image.

In the above embodiments, the present image 62 taken by the CT scanner 16 is compared with the past images 66 which were also taken by the CT scanner 16. However, in a case where images are taken from a patient by a MRI scanner as well as a CT scanner under similar condition to each other, it is possible to display the image taken by the CT scanner and the corresponding image taken by the MRI scanner for comparison, wherein the CT image may be a present image and the MRI image may be a past image, or vise versa. Moreover, if the follow-up examinations have been made several times by CT inspections and several times by MRI inspections, the results of the CT inspections and the results of the MRI inspections may be displayed side by side. In that case, by correlating the results of the CT inspections with the results of the MRI inspections, it comes to be possible to display and compare the corresponding images taken by the different modalities synchronously with each other.

Although the correspondence data 58 is produced in the image server 20 in the above embodiment, the correspondence data 58 may be produced in another device, for example, in the department terminal 10 or in the image interpretation report making terminal 12.

Although the medical network system of the above embodiment is an intra network system for use in a single medical facility, the present invention is not limited to this embodiment, but may be applicable to a network system networking a plurality of medical facilities.

Although the present invention has been described with reference to the medical network system 2 where the device under test is a patient, the present invention is not to be limited to the above embodiment, but may be applicable to an examination system where the device under test is an animal, or a nondestructive inspection system where the device under test is an object or article. Moreover, the present invention may be configured as a software program.

Thus, the present invention is not to be limited to the above embodiments but, on the contrary, various modifications will be possible without departing from the scope of claims appended hereto.

What is claimed is:

1. An image display system comprising:
a data storage device for storing past data obtained through a past examination done on a test device, and present data obtained through a present examination of said test device under similar condition to said past examination, wherein said past data includes past images taken from said test device at diverse imaging positions, whereas said present data includes present images taken from said test device at diverse imaging positions;
a correspondence data producing device for producing correspondence data that shows correspondence between said present images and said past images with respect to their imaging positions;
a display device for displaying said present images and/or said past images;
a designating device for designating at least one of said present images; and
a display control device for controlling said display device, said display control device having a normal mode for displaying merely the designated present image on said display device, and a sequential comparison mode for extracting a corresponding past image to the designated present image from said past data with reference to said correspondence data, and displaying the designated present image and the corresponding past image in turn on said display device.

2. An image display system as recited in claim 1, wherein if said test device has gone through past examinations plural times under similar condition, said display control device extracts corresponding past images to the designated present image from respective past data of said past examinations and displays the designated present image and the corresponding past images in turn on said display device in said sequential comparison mode.

3. An image display system as recited in claim 2, further comprising a device for indicating which examination the image displayed on said display device was taken at.

4. An image display system as recited in claim 1, wherein said display control device may control said display device to display a plural number of present images or corresponding past images to the respective present images at a time in said sequential comparison mode.

5. An image display system as recited in claim 1, wherein said display control device further has a parallel comparison mode for displaying the corresponding past image and the designated present image in parallel on said display device, wherein the past and present images are scrollable synchronously to display another couple of present and corresponding past images.

6. An image display system as recited in claim 5, wherein said present images and said past images are each a series of slice images taken by tomography, and said display control device scrolls said present and corresponding past images in said parallel comparison mode in the same sequence as slicing of said test device.

7. An image display system as recited in claim 5, wherein said display control device may control said display device to display a plural number of present images and corresponding past images to the respective present images at a time in said parallel comparison mode.

8. An image display system as recited in claim 5, wherein if said test device has gone through past examinations plural times under similar condition, said display control device extracts corresponding past images to the designated present image from respective past data of said past examinations and displays the designated present image and the corresponding past images in parallel on said display device in said parallel comparison mode.

9. An image display system comprising:
a data storage device for storing past data obtained through a past examination done on a test device, and present data obtained through a present examination done on said test device under similar condition to said past examination, wherein said past data includes past images taken from said test device at diverse imaging positions, whereas said present data includes present images taken from said test device at diverse imaging positions;
a correspondence data producing device for producing correspondence data that shows correspondence between said present images and said past images with respect to their imaging positions;
a display device for displaying said present images and/or said past images;
a designating device for designating at least one of said present images; and
a display control device for controlling said display device, said display control device having a normal mode for displaying merely the designated present image on said display device, and a comparison mode for extracting a corresponding past image to the designated present image from said past data with reference to said correspondence data, and displaying the designated present image and the corresponding past image on said display device.

10. An image display apparatus comprising:
a display device for displaying present images taken from a test device at a present examination and/or past images taken from said test device at a past examination under similar condition, said present and past images being taken at diverse imaging positions of said test device;
a correspondence data producing device for producing correspondence data that shows correspondence between said present images and said past images with respect to their imaging positions;
a designating device for designating at least one of said present images; and
a display control device for controlling said display device, said display control device having a normal mode for displaying merely the designated present image on said display device, and a comparison mode for retrieving a corresponding past image to the designated present image with reference to said correspondence data, and displaying the designated present image and the corresponding past image on said display device.

11. An image display apparatus as recited in claim 10, wherein said comparison mode includes a sequential comparison mode for displaying the designated present image and the corresponding past image in turn on said display device.

12. An image display apparatus as recited in claim 10, wherein said comparison mode includes a sequential comparison mode for displaying the designated present image and the corresponding past image in parallel on said display device.

13. An image display method for displaying present images taken from a test device at a present examination and past images taken from said test device at a past examination under similar condition, said present and past images being taken at diverse imaging positions of said test device, said method comprising steps of:
producing correspondence data that shows correspondence between said present images and said past images with respect to their imaging positions;
designating at least one of said present images;
displaying merely the designated present image on said display device in a normal mode;
retrieving a corresponding past image to the designated present image with reference to said correspondence data in a comparison mode; and
displaying the designated present image and the corresponding past image in turn or in parallel on said display device in said comparison mode.
